(19) United States
(12) Patent Application Publication
(10) Pub. No.: US 2006/0208433 A1
(43) Pub. Date: Sep. 21, 2006

(54) Tool-holding chuck for use with a rotating machine

(75) Inventor: Yves Cachod, Levier (FR)

Correspondence Address: OLIFF & BERRIDGE, PLC, P.O. BOX 19928, ALEXANDRIA, VA, 22320, US

(73) Assignee: ETABLISSEMENTS AMYOT S.A., PONTARLIER (FR)

(21) Appl. No.: 11/369,857

(22) Filed: Mar. 8, 2006

(30) Foreign Application Priority Data
Mar. 16, 2005 (FR) 05.02586

(51) Int. Cl. B23B 31/12

(52) U.S. Cl. 279/63

(57) ABSTRACT

Chuck comprising a cage in which there are mounted, and guided translationally, multiple jaws converging in the forward direction to grip a tool. The cage is made from at least one flat piece of sheet metal that is cut, folded and/or stamped to form inward-facing grooves for guiding the jaws, and that is closed on itself to form a tubular cage serving to house the jaws and other components, notably jaw driving components.

### BACKGROUND OF THE INVENTION

The present invention relates to a tool-holding chuck for use with a rotating machine. The function of a chuck mounted on the shaft of a rotating machine is to hold a tool, such as a drill bit in the case of a drill. The tool is held in the chuck by three jaws sliding in cavities formed inside the chuck. To guide the jaws accurately, the cavities possess a cross section of generally circular form and converge forwards in such a way that as the jaws move axially forwards, they approach one another and thereby grip the tool, whereas when the jaws are moved backwards the tool is released. The jaws possess an internally or externally threaded part which can be rotated either by a threaded central insert or by a peripheral nut turned by a sleeve.

A chuck is made of steel, and achieving its final structure requires numerous machining steps which are very expensive. Furthermore, making the jaws also requires machining steps which increase the cost price of the chuck.

### SUMMARY OF THE INVENTION

It is an object of the invention to provide a chuck of reduced cost price that nevertheless offers the same functions and the same performance as traditionally made chucks.

To this end, the chuck to which the invention relates, of the type comprising a cage in which there are mounted, and guided translationally, multiple jaws converging in the forward direction to grip a tool, is characterized by the fact that the cage is made from at least one flat piece of sheet metal that is cut, folded and/or stamped to form inward-facing grooves for guiding the jaws, and that is closed on itself to form a tubular cage serving to house the jaws and other components, notably jaw driving components.

Owing to its structure, this chuck is produced in a simple and inexpensive manner since it is made from at least one flat piece of sheet metal that is cut, folded and shaped before being closed on itself to form a tubular cage.

One possible feature is that the chuck is made from a part made by cutting a flat piece of sheet metal and having a central ring designed to form the front end of the chuck, from which extend three wings, in each of which there is folded or stamped a groove turned towards the center of the ring and serving to guide a jaw, the wings all being bent towards the same side of the ring and each being fixed to the other two wings, to form a tubular cage.

Advantageously, the fixing of each wing to a neighboring wing is effected by crimping of the rear of the cage.

Another possible feature is that the cage is made from three flat pieces of sheet metal that are cut, folded and/or stamped, each defining a groove for guiding a jaw, and welded to each other to form a tubular cage serving to house the jaws and other components, notably jaw driving components.

Also, each of the three shaped pieces of sheet metal overlaps its neighbor and each piece of sheet metal comprises two front wings and two rear wings of different widths arranged on either side of a central part in which a groove is designed to be formed, the widest front wing and the widest rear wing being situated on either side of the central part, these two front and rear wings each being designed to cover the front and rear wings of the two pieces of sheet metal situated on either side of the piece of sheet metal in question, while the two narrower wings of this piece of sheet metal are at least partly overlapped by the wings of the two adjacent pieces of sheet metal.

This inverted overlapping of the front and rear wings of a piece of sheet metal, with respect to the front and rear wings of the neighboring pieces of sheet metal, improves the rigidity of the cage made from these pieces of sheet metal.

Advantageously, and in order further to improve the rigidity of the body, the wider front and rear wings of any particular piece of sheet metal are offset laterally with respect to each other, in such a way that the rear wing of one piece of sheet metal contacts the outer wall of a groove formed by a neighboring piece of sheet metal, and that the front wing of the piece of sheet metal contacts the outer wall of a groove formed by the other neighboring piece of sheet metal.

In one embodiment, this chuck comprises a threaded central body engaging with teeth on the inside of each jaw. In this case, the regions of the cage lying between the jaw guide grooves define a cylindrical envelope serving to accommodate the central body.

In one embodiment of this chuck, the central body comprises an annular groove and the cage comprises at least one bridge capable of being deformed inwards so as to engage in the groove formed in the body, in order axially to retain the body while allowing it to rotate.

In another embodiment of this chuck, the rear end of the cage is equipped with, lying in a plane perpendicular to the axis of the chuck, a metal closing ring that comprises bent tabs contacting the outer face of the pieces of sheet metal, and that is fixed to these by welding, the central body passing through this ring, and the ring contacting a shoulder on the central body in order to keep it inside the cage.

Advantageously, the central body comprises, on its rear part extending out of the cage, knurling designed to take a so-called rear ring or holding ring comprising a tubular part engaged and locked on the central body, a ring-shaped part perpendicular to the chuck axis, and, parallel to the chuck axis, a skirt situated at a distance from the axis approximately equal to the greatest distance from this same axis of the parts of the cage that comprise the jaw guide grooves.

Also, the cage of the chuck is surrounded by a so-called tightening ring that pivots with the cage.

To lock the jaws when the chuck is ready to use, the central body comprises, ahead of the knurling designed to take the rear ring, peripheral teeth and the cage supports a locking means designed to be engaged in the teeth of the body when the chuck is tightened, and actuable by the tightening ring which possesses a relative angular movement with respect to the cage and to the locking means, and moves the latter from an unlocked to an locked position in the course of this angular movement.

In one embodiment, the locking means comprises a leaf spring fixed to the cage and possessing a free end that is normally held away from the teeth by its elasticity, when it is housed in a recess formed in the tightening ring, and that is engaged with the teeth of the body when in contact with a surface of the tightening ring.

To index the locking ring between the locked and unlocked positions of the chuck, the leaf spring comprises an outwardly projecting second end designed to engage in either of two cavities formed in the inner face of the tightening ring, allowing the tightening ring to be secured in either the locked or unlocked position.

Also, the tightening ring comprises at least one inwardly projecting element designed to contact one of the parts of the cage comprising a guide groove for a jaw in order to drive the cage in the tightening direction, and at least one inwardly projecting element designed to contact one of the parts of the cage comprising a guide groove for a jaw in order to drive the cage in the loosening direction.

In one possible feature the tightening ring is kept in its axial position on the cage by a radial retainer belonging to the ring and contacting a shoulder on the front part of the cage.

### BRIEF DESCRIPTION OF THE DRAWINGS

At all events, a clear understanding of the invention will be gained from the following description referring to the accompanying schematic drawing showing, by way of nonrestrictive example, two embodiments of this chuck, equipped with a threaded central body engaging with teeth on the inside of each jaw.

FIG. 1 is a perspective view of a first chuck;

FIG. 2 is a flat view of a flat piece of sheet metal from which the chuck is made;

FIGS. 3 and 4 are two perspective views of the cage of this chuck seen in three-quarter front and three-quarter rear view, respectively;

FIG. 5 is a side view of the central body of the chuck equipped with two jaws;

FIG. 6 is a longitudinal section through this chuck equipped with a drill bit;

FIG. 7 is a cross section through this chuck taken on VII-VII as marked in FIG. 6;

FIGS. 8 and 9 are two cross sections through this chuck, in the locked and unlocked positions, respectively;

FIG. 10 is an exploded perspective view of a second chuck;

FIG. 11 is a flat view of one of the three sheet metal blanks from which the cage is made;

FIG. 12 is an exploded perspective view of this chuck being assembled;

FIG. 13 is a longitudinal section through this chuck in the assembled position; and

FIGS. 14 and 15 are two cross sections through this chuck, in the unlocked and locked positions, respectively.

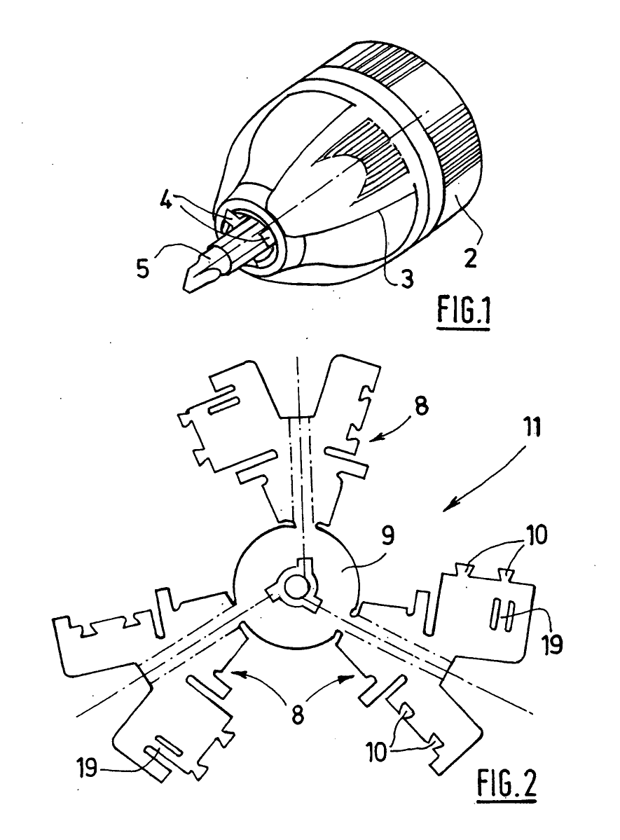

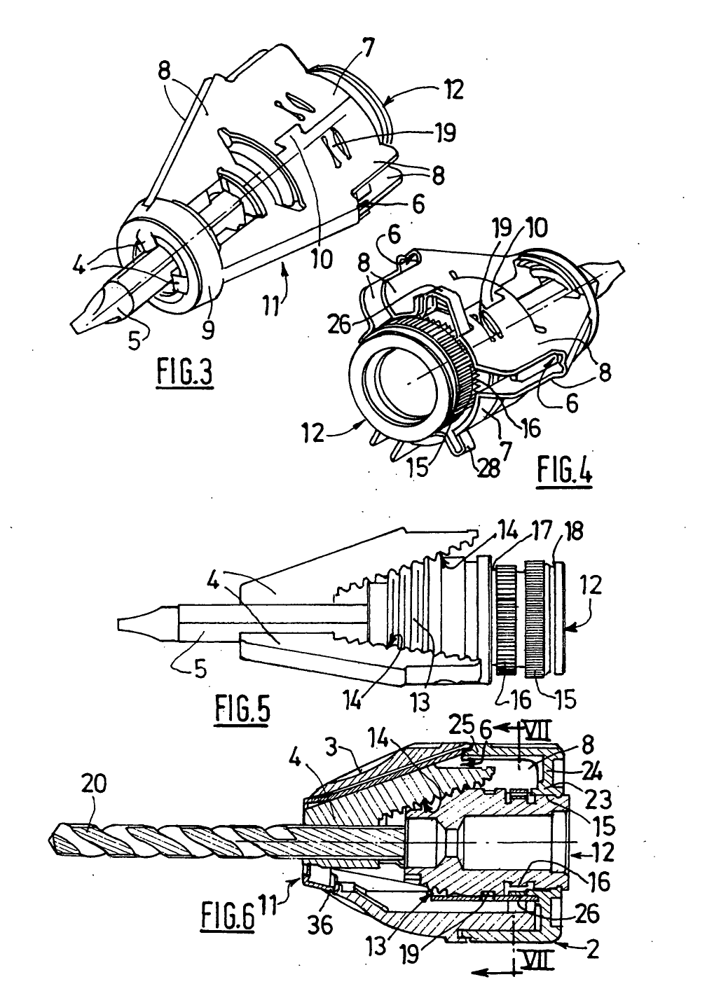

### DESCRIPTION OF THE PREFERRED EMBODIMENTS

FIG. 1 shows a first chuck whose outer surface shows a rear holding ring 2, a front tightening ring 3, three rectangular-section jaws 4 gripping a tool 5 whose shank is of hexagonal section and whose active part may for example be a screwdriver.

In accordance with the essential feature of this chuck, the cage 11 is made from a flat piece of sheet metal that is cut, folded and/or stamped to form grooves 6 to guide the jaws, and is closed on itself to form a tubular body defining a cylindrical envelope 7 for installing the jaws and other components, particularly jaw driving components.

In the present case, the flat piece of sheet metal is cut to give three wings 8 that define three grooves 6, each to guide one jaw, these three wings being connected by a central ring 9. The wings are bent, after shaping, to the same side of the ring, and are assembled by in particular an outline dovetail system 10 and by crimping at the rear of the cage 11. The cylindrical envelope 7 defined by the cage takes a central body 12 having a thread 13 designed to mesh with teeth 14 on the inside face of each jaw. As shown in the drawing, the central body 12 has knurling 15 at its rear, front locking teeth 16, a groove 17 for fixing the body to the cage, and a groove 18 for fixing the rear holding ring 2. In practice, the cage comprises bridges 19 that can be deformed inwards to engage in the groove 17 in the body in order to provide axial retention of the body while allowing it to rotate.

As shown particularly in FIG. 6, which depicts the chuck in longitudinal section, equipped with a tool represented by a drill bit 20, the rear holding ring 2 comprises a tubular part 23 engaged on the knurling 15 of the central body 12 and extended outwards by a radial ring-shaped part 24. This part 24 is itself extended by an annular skirt 25 situated at a distance from the axis approximately equal to the greatest distance from this same axis of the parts of the cage 11 that contain the jaw 4 guide grooves 6.

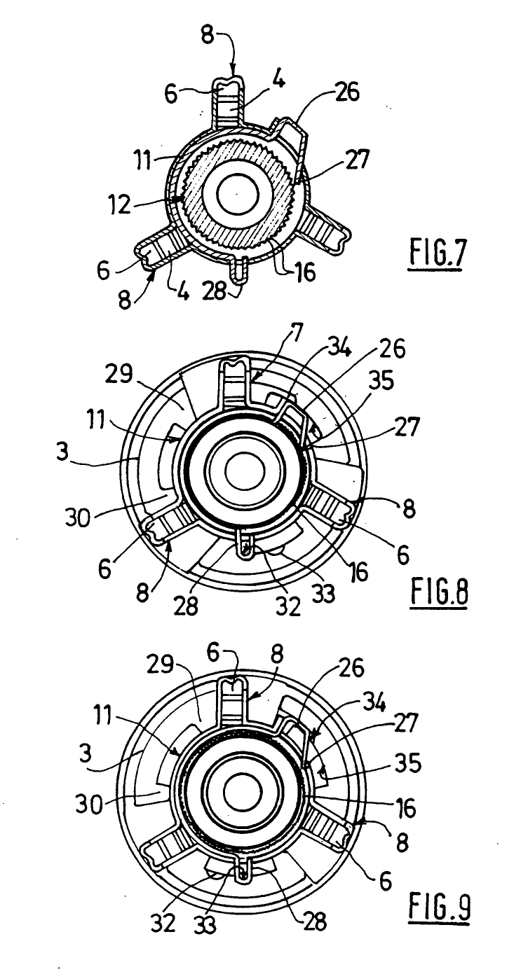

As shown particularly in FIGS. 6 to 9, the cage 11 is equipped, around the locking teeth 16 of the central body 12, with a leaf spring 26 which is fixed to the cage and comprises a first free end 27 normally held off the teeth by its elasticity, as shown in FIG. 7, when there is no stress applied to it. However, it can engage with the teeth 16 if stress is applied to it from the outside.

The other end of the leaf spring presents an outward-turned loop 28. The part of the cage equipped with the leaf spring 26 is surrounded by the rear end of the tightening ring 3. This tightening ring has two stops 29 and 30 designed to bear against two shoulders corresponding to two relief parts containing the jaw guide regions, in order to turn the cage in either direction. In addition, the tightening ring 3 has, on its inner face, two cavities 32 and 33 designed to receive the end 28 of the leaf spring, to provide two indexed positions, namely the locked position and the unlocked position.

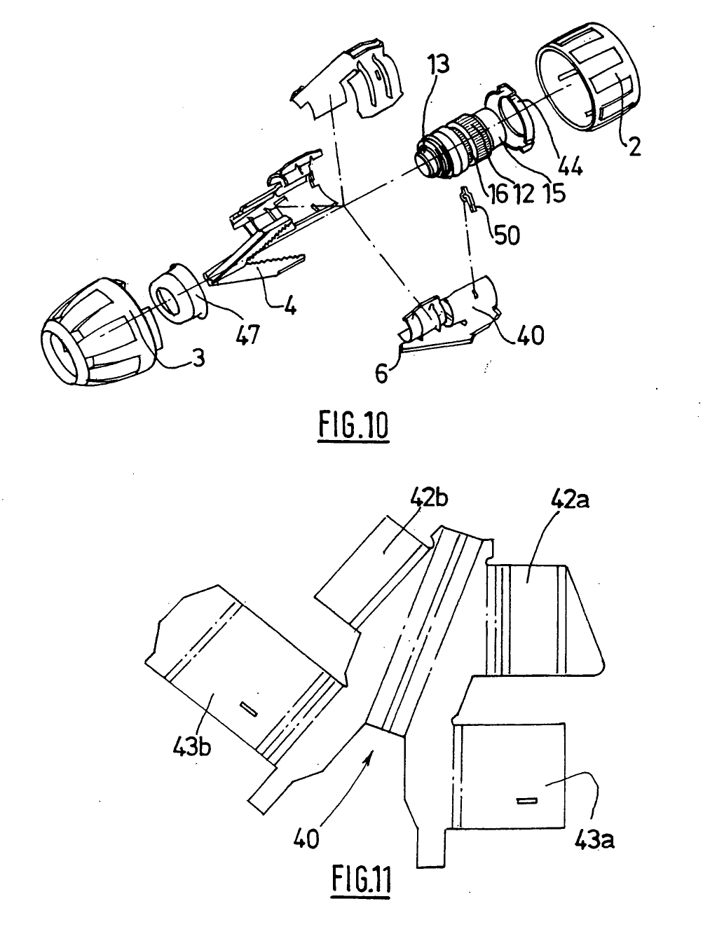

The ring 3 also comprises, on its inner face, a recess 34 which is continued by a smaller-radius surface 35, the recess 34 and the surface 35 being designed to act on the end 27 of the leaf spring 26 to keep the end 27 engaged with the teeth 16 when the end of the leaf is in contact with the surface 35, as shown in FIG. 8, or to allow this end 27 to disengage from the teeth when the end of the leaf is sitting in the recess 34, as shown in FIG. 9.

Lastly, the tightening ring is kept in position on the cage 11 by a radial retainer 36 bearing against a shoulder on the front part of the cage.

From a practical point of view, this chuck is used in the traditional way, the operator holding the rear holding ring 2 and closing the jaws 4 by turning the tightening ring 3. At the end of the tightening movement, the chuck is locked by the same movement when the end 27 of the leaf spring 26 engages with the locking teeth 16. The chuck is released by proceeding in reverse.

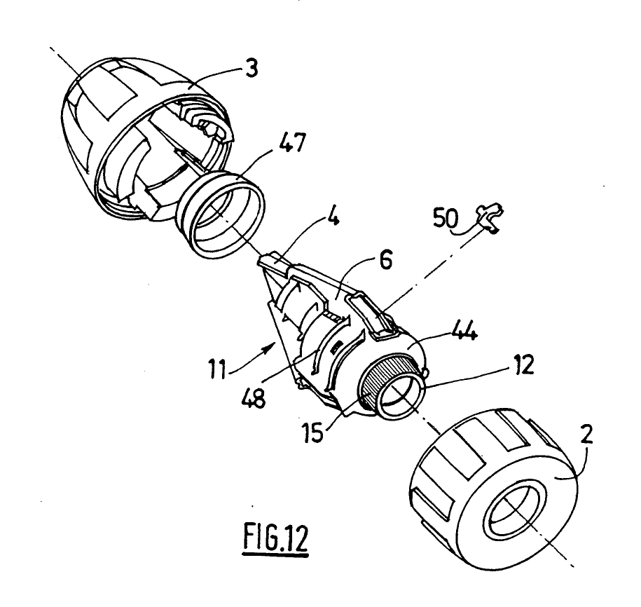

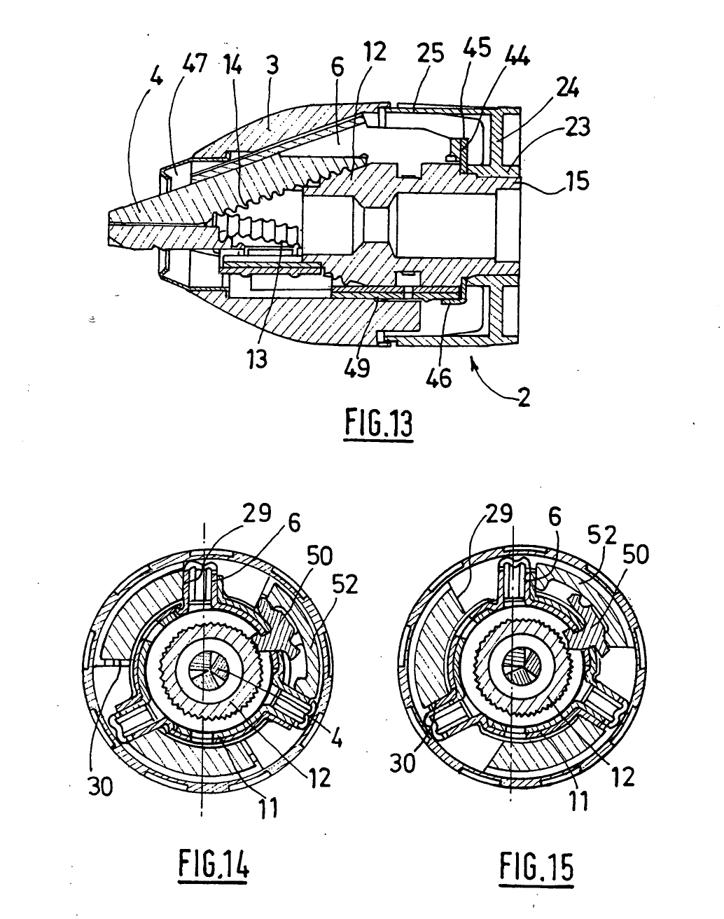

FIGS. 10 to 15 show a second embodiment of the chuck in which the same components are denoted by the same references as before.

The difference with this second chuck is that the cage 11 is made not from one piece of sheet metal, but from three sheet metal parts assembled together.

Each of the these sheet metal parts is denoted by the reference 40. Each sheet metal part is made, as shown in FIG. 11, from a flat sheet metal blank produced by cutting and then folded and/or stamped to form a groove 6 for the guidance of a jaw 4. As can be seen in FIG. 11, each piece of sheet metal has a central part in which a groove 6 is to be formed for guiding a jaw. Extending out from this are two front wings 42a, 42b and two rear wings 43a, 43b. The front wing 42a is wider than the wing 42b, and the rear wing 43b is wider than the rear wing 43a. The wings 42a and 43b overlap the adjacent wings of the two neighboring pieces of sheet metal and contact a portion of each of these pieces of sheet metal to form a groove 6. The wings 42b and 43a, for their part, are overlapped by the wings 42a and 43b of the adjacent pieces of sheet metal.

The advantage of this arrangement is its good rigidity. The various parts 40 are joined together by welding.

In practice, following assembly of the three parts 40 of the cage, the jaws 4 and the central body 12 are introduced into the cage. The rear end of the cage is then closed by a ring 44 allowing the central body to pass through, and contacting a shoulder 45 of this body. The ring 44 possesses bent tabs 46 bearing on the outer face of the cage. The ring 44 is fixed to the cage 11 by spot welding.

The front tightening ring 3 is equipped with a metal nose 47, which is inserted forwards from the rear of the ring before the ring is fitted to the front part of the cage 11. The front tightening ring 3 is kept locked on the cage 11 a rib 48 formed on the cage, transversely relative to the axis, engaging with a radial retainer 49 formed on the inside face of the ring.

As in the previous embodiment, this chuck is equipped with a locking element 50 designed to engage with the locking teeth of the body.

As in the previous embodiment, the front tightening ring has at least two stops 29, 30 designed to bear against the outer faces of the cage corresponding to two jaw guide parts, in order to turn the cage in either direction.

As in the previous embodiment, the inner wall of the ring has a portion 52 designed to operate the locking element 50 to move it to an unlocked position, as shown in FIG. 14, or to keep it in the locked position, as shown in FIG. 15.

It goes without saying that the locking device described with reference to the first embodiment could also be employed in the chuck corresponding to the second embodiment.

Clearly, the invention is not limited only to those of the chuck's embodiments that have been described above by way of example: on the contrary, it covers all variants thereof. To take one particular example, the chuck need not have a threaded central body 12 but could be equipped with a nut surrounding the jaws and driving externally threaded portions of the jaws, without thereby departing from the scope of the invention.

1. A tool-holding chuck for use with a rotating machine, of the type comprising a cage in which there are mounted, and guided translationally, multiple jaws converging in the forward direction to grip a tool, wherein the cage is made from at least one flat piece of sheet metal that is cut, folded and/or stamped to form inward-facing grooves for guiding the jaws, and that is closed on itself to form a tubular cage serving to house the jaws and other components, notably jaw driving components.

2. The chuck as claimed in claim 1, for housing three jaws, which is made from a part made by cutting a flat piece of sheet metal and having a central ring designed to form the front end of the chuck, from which extend three wings, in each of which there is folded or stamped a groove turned towards the center of the ring and serving to guide a jaw, the wings all being bent towards the same side of the ring and each being fixed to the other two wings, to form a tubular cage.

3. The chuck as claimed in claim 1, wherein the fixing of each wing to a neighboring wing is effected by crimping the rear of the cage.

4. The chuck as claimed in claim 1, for housing three jaws, wherein the cage is made from three flat pieces of sheet metal that are cut, folded and/or stamped, each defining a groove for guiding a jaw, and welded to each other to form a tubular cage serving to house the jaws and other components, notably jaw driving components.

5. The chuck as claimed in claim 4, wherein each of the three shaped pieces of sheet metal overlaps its neighbor and each piece of sheet metal comprises two front wings and two rear wings of different widths arranged on either side of a central part in which a groove is designed to be formed, the widest front wing and the widest rear wing being situated on either side of the central part, these two front and rear wings each being designed to cover the front and rear wings of the two pieces of sheet metal situated on either side of the piece of sheet metal in question, while the two narrower wings of this piece of sheet metal are at least partly overlapped by the wings of the two adjacent pieces of sheet metal.

6. The chuck as claimed in claim 5, wherein the wider front and rear wings of any particular piece of sheet metal are offset laterally with respect to each other, in such a way that the rear wing of one piece of sheet metal contacts the outer wall of a groove formed by a neighboring piece of sheet metal, and that the front wing of the piece of sheet metal contacts the outer wall of a groove formed by the other neighboring piece of sheet metal.

7. The chuck as claimed in claim 1, comprising a threaded central body engaging with teeth on the inside of each jaw, wherein the regions of the cage lying between the jaw guide grooves define a cylindrical envelope serving to accommodate the central body.

8. The chuck as claimed in claim 7, wherein the central body comprises an annular groove and the cage comprises at least one bridge capable of being deformed inwards so as to engage in the groove formed in the body, in order axially to retain the body while allowing it to rotate.

9. The chuck as claimed in claim 7, wherein the rear end of the cage is equipped with, lying in a plane perpendicular to the axis of the chuck, a metal closing ring that comprises bent tabs contacting the outer face of the pieces of sheet metal, and that is fixed to these by welding, the central body passing through this ring, and the ring contacting a shoulder on the central body in order to keep it inside the cage.

10. The chuck as claimed in claim 7, wherein the central body comprises, on its rear part extending out of the cage, knurling designed to take a so-called rear ring or holding ring comprising a tubular part engaged and locked on the central body, a ring-shaped part perpendicular to the chuck axis, and, parallel to the chuck axis, a skirt situated at a distance from the axis approximately equal to the greatest distance from this same axis of the parts of the cage that comprise the jaw guide grooves.

11. The chuck as claimed in claim 7, wherein the cage of the chuck is surrounded by a so-called tightening ring that pivots with the cage.

12. The chuck as claimed in claim 10, wherein the central body comprises, ahead of the knurling designed to take the rear ring, peripheral teeth and the cage supports a locking means designed to be engaged in the teeth of the body when the chuck is tightened, and actuable by the tightening ring which possesses a relative angular movement with respect to the cage and to the locking means, and moves the latter from an unlocked to a locked position in the course of this angular movement.

13. The chuck as claimed in claim 12, wherein the locking means comprises a leaf spring fixed to the cage and possessing a free end that is normally held away from the teeth by its elasticity, when it is housed in a recess formed in the tightening ring, and that is engaged with the teeth of the body when in contact with a surface of the tightening ring.

14. The chuck as claimed in claim 13, wherein the leaf spring comprises an outwardly projecting second end designed to engage in either of two cavities formed in the inner face of the tightening ring, allowing the tightening ring to be secured in either the locked or unlocked position, respectively.

15. The chuck as claimed in claim 11, wherein the tightening ring comprises at least one inwardly projecting element designed to contact one of the parts of the cage comprising a guide groove for a jaw in order to drive the cage in the tightening direction, and at least one inwardly projecting element designed to contact one of the parts of the cage comprising a guide groove for a jaw in order to drive the cage in the loosening direction.

16. The chuck as claimed in claim 11, wherein the tightening ring is kept in its axial position on the cage by a radial retainer belonging to the ring and contacting a shoulder on the front part of the cage.
